(19) United States
(12) Patent Application Publication
(10) Pub. No.: US 2014/0304093 A1
(43) Pub. Date: Oct. 9, 2014

(54) METHOD AND SYSTEM TO PROMOTE SALES OR SERVICES WITH SOCIAL SALES POINT

(71) Applicants: Xuejiang Cheng, Plano, TX (US); Eng-Keong David Lee, Plano, TX (US); Kalyan Das, Frisco, TX (US)

(72) Inventors: Xuejiang Cheng, Plano, TX (US); Eng-Keong David Lee, Plano, TX (US); Kalyan Das, Frisco, TX (US)

(21) Appl. No.: 14/102,419

(22) Filed: Dec. 10, 2013

Related U.S. Application Data
(60) Provisional application No. 61/809,763, filed on Apr. 8, 2013.

(51) Int. Cl. G06Q 20/20; G06Q 20/12

(52) U.S. Cl. CPC G06Q 20/20; G06Q 20/12
USPC 705/16

(57) ABSTRACT

The present disclosure is directed towards small modules, web plugins, which may be placed on any influential content which simplify and promote sales by operating as a social sales point (SSP). SSP's simplify sales by avoiding buyers engaging in any further searches or product comparisons. The sales process is promoted and supported by the inherent trust and revere placed upon the content owner, with the influential content providing a framework to complete the transaction and close the sale. Additionally, SSP promotes sales by keeping track of the reward of referrers, and provide a fair way of sharing reward with this social middle man. SSP allows simple proliferation, so that any effective promotion will quickly spread to its maximum by the power of social media.

### CROSS REFERENCE TO RELATED APPLICATIONS

This present application claims the priority benefit of U.S. provisional patent application Ser. No. 61/809,763 filed Apr. 8, 2013, the disclosure of which is incorporated herein by reference.

### TECHNICAL FIELD

This disclosure relates in general to the field of web plugins and more particularly to systems and methods for leveraging social networks for promoting sales and services.

### BACKGROUND

The traditional sales process is often embodied in brick-and-mortar, physical retail stores, which includes, but is not limited to: 1) displaying items locally, 2) selling items to consumers, and 3) earning profits on sales of those items. However, this model of sales is filled with inefficiencies and suitable for improvement for increasing profitability.

Electronic commerce (e-commerce), the buying and selling of products and services over electronic systems such as the Internet, is an industry further taking advantage of technology to transform sales processes. Not only does e-commerce reduce the need for local store overhead. The e-commerce sales model reduced the cost for start up and reduced the cost to operate. Its efficiency and flexibility has attracted many people to become sellers and/or buyers. For example, eBay provides an auction platform for buyers and sellers to bargain directly, cutting out middle-men sellers.

Further, e-commerce allowed a new kind of commerce, such as Amazon, to emerge and be successful. Many of the traditional brick-and-mortar stores have also seen the impact of e-commerce, and have opened their own e-commerce branches, such as WalMart.

Online search engines often display advertisements for products and services, based upon inputted search terms. This practice has now become standard practice in the e-commerce industry. Recently, retailers have begun posting advertising links on social websites, such as Facebook or personal blogs. They hope to use the medium of social websites to promote sales. However, these links do not operate much differently than search engine advertisements.

There are two main problems with this type of simple advertisement links. First, it brings the reader to a different page than where the link was posted, which creates disconnects between the social website and the promoted item, which is now displayed to the reader via a commercial website using advertisement link. The reader may love the social website but dislike the commercial web site. This reduces the appeal of the promoted item as a potential purchase to the reader. Second, it does not provide a direct connection between the sales transaction and an individual promoting the item on the social website. This dampens the enthusiasm of the individuals who promote the item and diminishes the potential power of social connectivity.

Although various methods for improving access to online customers and converting them into sales are known to the art, all, or almost all of them suffer from one or more than one disadvantage and have shortcomings. Therefore a need has arisen for enabling a more intimate person-to-person interactions through a web plugin associated with content providers on social websites which corrects the problems identified above.

### SUMMARY

The present disclosure is directed towards web plugins and their method of use in leveraging social networks for promoting online sales. The following disclosure presents concepts for providing a web plugin capable of easy distribution and embedding into web pages, such as a personal Blog or online social network page. As used herein, the term “Social Sales Point” (hereinafter, SSP), alone or in combination, refers to a web plugin comprising an image and text link, and further carries additional information and functions.

One aspect of the disclosed subject matter is the inclusion within SSP data, the identification of the content provider who promotes the sales. We also call this person as the referrer.

Another aspect of the disclosed subject matter is the inclusion within SSP data, the identification of the item to be sold.

Yet another of the disclosed subject matter is the inclusion within SSP data, additional links that may provide additional information to complete the intended sale.

SSP's contain full functionalities to complete sales right on-site of the containing page. This makes the sale a natural part of the containing page, maximizing the authenticity and influence of the referrer. SSP's directly link the transaction back to the referrer.

To increase the spread and therefore usefulness, SSP's may also have a share feature that enable buyers and readers of blogs to copy a SSP onto their own web site from another one, under their own name. This feature ensures the spread of the SSP across a channel that potentially connects to many other Internet users with common interests.

SSP's may be managed by a dedicated business for tracking and technical support. It is created by the seller of merchandise who purchases the service. The SSP is then able to be requested by a referrer for use on a social website (e.g., by a blogger for a blog). By creating a stronger link between sellers, buyers, and referrers, SSP create a new marketing model that leverages the power of social network.

One skilled in the art would recognize that SSP's are not limited to sales applications necessitating the transfer of monetary amounts. Alternatively, SSP's may be utilized as a recommendation tool for various products or services. A user could interact with the SSP in a manner similar to using a coupon. The SSP could include additional barcode information identifying the individual who recommended the product or service. In this way, the SSP enables the tracking and giving reward due to the individual who recommended the product or service.

Among the many different possibilities contemplated, the system may advantageously integrate technologies in a new way that provides a business relation between merchandise, referrers and buyers. These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims filed later.

### BRIEF DESCRIPTIONS OF THE DRAWINGS

The novel features believed characteristic of the presently disclosed subject matter will be set forth in any claims that are filed later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 illustrates generally an exemplary diagram of the SSP marketing process of the present disclosure.

FIG. 2 illustrates an exemplary embodiment of a SSP as implemented within a social networking site.

FIG. 3 illustrates a popup for presenting additional SSP information.

FIG. 4 is a block diagram depicting a system for delivering SSP processes, according to an example embodiment.

FIG. 5 is a block diagram illustrating an environment for operating a mobile device, according to an example embodiment.

FIG. 6 is a block diagram illustrating a mobile device, according to an example embodiment.

FIG. 7 is a block diagram illustrating a network-based system for delivering SSP services, according to an example embodiment.

FIG. 8 is a block diagram illustrating an example SSP host, according to an example embodiment.

FIG. 9 is a block diagram of a machine in the example form of a computer system.

### DETAILED DESCRIPTION OF THE SPECIFIC EMBODIMENTS

Although described with particular reference to web plugins, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The detailed description set forth below in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

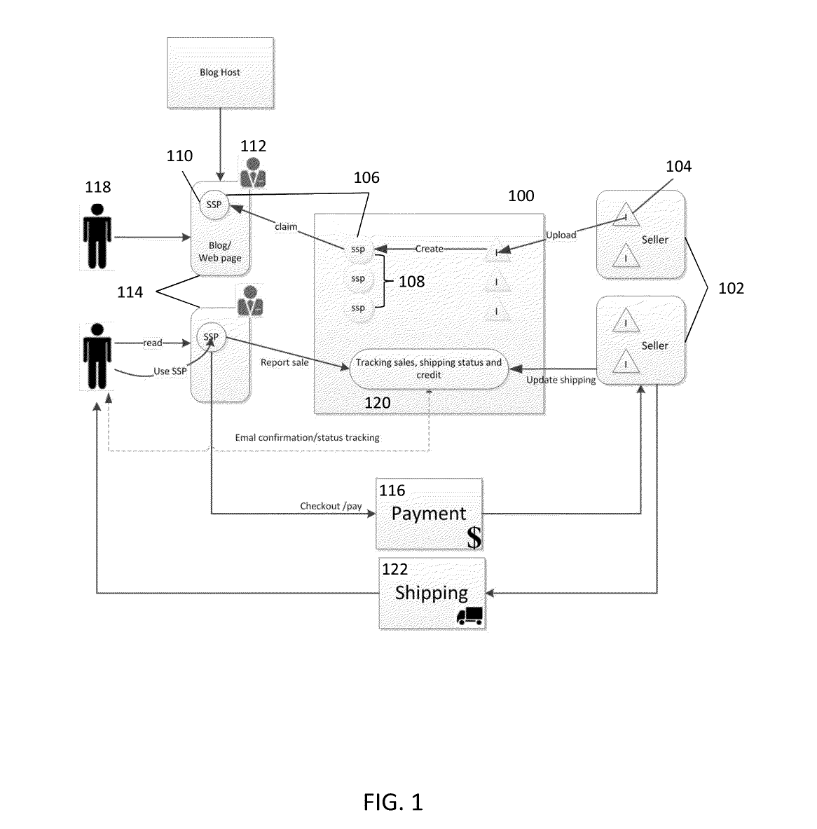

FIG. 1 illustrates generally an exemplary diagram of the SSP marketing process. The present disclosure is directed towards small modules (e.g., web plugins) which may be placed on influential content to simplify and promote sales by operating as a social sales point (SSP). SSP's simplify sales by avoiding buyers engaging in further searches or product comparisons. The sales process is promoted and supported by the inherent trust and revere placed upon the referrer, with the influential content, providing a framework to complete the transaction and close the sale.

### DEFINITIONS

Seller: For the purposes of this specification and the associated claims, the term “seller” refers to an individual or company that owns the items to be sold. For a sale to occur, the seller first uploads item information to a SSP host. The SSP host creates a SSP template for a seller to use. When a sale is completed, the seller is responsible for shipping the item to the buyer and providing a profit share to the SSP host.

Item: For the purposes of this specification and the associated claims, the term “item” refers to the goods and services to be sold. It is the context that SSP can use to link the three parties: the seller, the referrer, and the buyer. An item may be associated with a name, a description, a picture, and a price. The item may also have additional information that is located at a seller website or on the SSP host.

Upload: For the purposes of this specification and the associated claims, the term “upload” refers to an uploading by the seller of item information to the SSP host.

SSP Host: For the purposes of this specification and the associated claims, the term “SSP host” refers to a web site that provides services to allow the creation and request of SSP.

Tracking: For the purposes of this specification and the associated claims, the term “tracking” refers to a responsibility of the SSP host for recording sales, tracking order status, and tracking profit share. The recording and tracking function may been implemented as is known in the art.

SSP: For the purposes of this specification and the associated claims, the term “SSP” refers to a web plugin that adds a specific feature to an existing software application, such as a web browser.

Content Provider/Referrer: For the purposes of this specification and the associated claims, the term “content provider” refers to individuals who share content (e.g., their ideas or experiences) on Blogs, Facebook, Twitter, or other web pages. The term “content provider” may also include blog owners or bloggers. Their primary goal is to let people enjoy the reading. While doing so, they may also promotes the sales that benefit all three parties, the seller, the buyer, and themselves. For the reason of referring, we also discuss the Content Provider in the context of being a referrer. Referrers may actively search and claim suitable SSPs and embed SSPs into their content. By embedding SSP, the referrer can make the whole process seamless.

Reader/Buyer: For the purposes of this specification and the associated claims, the terms “reader” or “buyer” refer to an individual (e.g., a blog reader) that interacts with content provided by the referrer. The reader of content, who may also be a potential buyer, may be associated with a blog likes to read. In addition to enjoying the blog, the reader may be likely to purchase the item that both the reader/buyer and content provider/referrer are interested in. With the SSP, the reader/buyer can easily do so without being redirected to other websites. There is not much of a reason for the reader/buyer to leave the blog and search for an item, since the reader/buyer is more likely to accept the price and quality of an item being promoted by an already trusted source (e.g., the referrer). With a few successful experiences, the reader/buyer may also become a potential referrer for sales of the item if the reader also owns a blog or posts on a social website. The SSP may include a ‘share’ function to allow duplication of the SSP coat with a new referrer's ID. The duplicated SSP may then be embedded into a new web page.

### Example Methods

Though described serially in the example of FIG. 1, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

The SSP host 100 may be implemented as including one or more computer program modules and/or instructions that may be executed to provide SSP functionalities. The one or more computer program modules may include one or more of an upload module, a SSP generation module, a SSP claiming module, a social-networking module, a purchase module, a tracking module, and/or other modules. A computer processor may be configured to execute the various modules by software; hardware; firmware; some combination of software, hardware, and/or firmware; and/or other mechanisms for configuring processing capabilities on the processor.

The upload module of SSP host 100 may be configured to provide, for presentation to one or more users (e.g., sellers) a user interface for uploading items for sale. The SSP host 100 begins by receives an uploading by the seller 102 of information relating to an item 104 for sale. This uploaded information for the item may include a name, a description, a picture, a price, and a quantity for the item to be sold. Further, the seller 102 may purchase credits from the SSP host 100 and specify an amount that the seller 102 is willing to pay for each successful transaction (e.g., a sale) of the item 104 that is associated with a SSP 106.

The SSP generation module may be configured to generate SSP's. The SSP 106 exists in two states: an unclaimed SSP state 108 and a claimed SSP state 110. The unclaimed SSP state 108 exists before the SSP 106 has been claimed by a referrer 112. It has no referrer ID and therefore cannot be used for tracking reward due to the referrer, but it is available to be examined by the referrer 112 for aesthetics, look and feel. The referrer 112 may make modifications to the SSP 106, in the unclaimed SSP state 108, so that it can fit better into the content of the social website 114 on which the SSP 106 is posted. Alternatively, modifications to the SSP 106 may be performed in the claimed SSP state 110.

After the referrer 112 claims the SSP 106, it becomes a claimed SSP. The claimed SSP state 110 exists after it has been claimed by a referrer 112. The claimed SSP includes a referrer ID and provides full functionality for completing one or more sales of the same type of items. It can be enabled and disabled from the SSP host 100 for any reason, such as if the item is out-of-stock.

Further, the SSP 106 comprises two components (not shown): a coat and a core. The SSP coat is comprises a shell of the SSP, containing the minimal information required to be embedded into the social website 114. The SSP coat contains the referrer's ID and item ID. It may contain functionality to retrieve the SSP core from the SSP host 100. This SSP coat does not require much knowledge and skill to have embedded into the social website 114.

The SSP core is comprised of a dynamically loaded portion from the SSP host 100 into the social website 114 at runtime, but is separate from the social website 114. This SSP core includes necessary UI code such as HTML and CSS. It also includes necessary script to pull additional information from the SSP host 100 or from a website of the seller 102. The SSP core also includes the code to integrate with a payment processor 116. Further, the SSP core is responsible for notifying the SSP host 100 regarding any completed sales.

The SSP 106 is primarily hosted by SSP host 100. Alternatively, the SSP 106 may be co-hosted by sellers 102, or other service providers. The purpose of co-hosting is to attract more referrers in addition to the referrer 112. However, the SSP 106 is still managed and tracked by SSP host 100. The SSP host transfers credits to referrers (not shown) for each successful transaction (e.g., sale of the item 104). Referrers may redeem the credit as money or redeem them for goods and/or services from other sellers or vendors.

The social-networking module may be configured to provide the SSP 106 of the SSP host 100 for viewing. The social-networking tool may allow the referrer 112 to interface with one or more social-networking services (e.g., Facebook™, MySpace™, Twitter™, Twitpic™, Flicker™, and/or other social-networking services) with which the referrer 112 is associated. The social-networking tool may interface with a social-networking website in order to share the SSP 106 with one or more contacts of the user. This SSP 106 may be provided as a web plugin link comprising an image and text link on the social website 114. By way of non-limiting example, the social-networking tool may interface with Facebook™ by entering the SSP as a snapshot with an associated comment on the profile page of the referrer. The comment may include a link (e.g., a uniform resource locator (URL)) to content (e.g., a website) and/or information associated with an item depicted in the snapshot.

The SSP 106 can operate in two modes: a fully online mode and a partially online mode. In the fully online mode, the SSP 106 fulfills its functions online with all involved parties. For example, after the seller 102 uploads information for item 104 to the SSP host 100, the SSP host 100 creates the SSP 106, which may be claimed by the referrer 112. A reader 118 interacting with the social website 114 uses the SSP 106 to purchase the item 104.

The purchase module may be configured to provide a purchase tool. The purchase tool may allow the user to indicate one or more items associated with the SSP to effectuate a purchase of the one or more items corresponding to the SSP 106 posted by the referrer 112. In some implementations, effectuating a purchase of an item may include adding that item in a shopping cart associated with a virtual-commerce environment for future purchase.

The tracking module may be configured to provide a tracking tool 120 capable of tracking a sale of the item 104, receiving updates regarding shipping statuses provided by the seller 102 or directly from a shipping service 122, and/or tracking credits due to the referrer 112 for completed transactions using the SSP 106 posted by the referrer 112 on the social website 114. Further, the tracking module may be configured to send communications (e.g., emails or text messages) regarding purchase or shipping status.

In the partially online mode (not shown), the SSP 106 spends a portion of its operating cycle off the Internet, where the SSP 106 requires other forms of processes to complete a transaction, wherein the complete transactions require other system and human interactions. The partially online mode is suitable for local services and sellers where the buyers are required to visit the local offices or stores. For example, a dentist may create a SSP for attracting additional patients. An existing patient may claim the SSP to add an existing patient ID. The existing patient may activate the SSP by adding a potential patient's information, such as email. The SSP will then send the potential patient an email, which includes the dentist's original statement and the referrer's testimony. This email also includes other information for the process purpose, such as a transaction ID. The potential patient can print the email or present it via a smart phone to the dentist office. After check-in the dentist office and completed the service, there are many ways to report to SSP Host. They may include: 1) office agent scan or type the transaction ID and send it to SSP Host. 2) the patient, enters the transaction ID into a dedicated SSP login for the office. 3) the patient take a confirmation code from the office and enter into a confirmation page of the SSP Host web site.

SSP can be passed to the buyer with two approaches: passive and active. With the passive approach, the SSP's are posted to social websites by the referrer. The posted SSP's are waiting to be utilized by a buyer. This approach is suited for the condition where referrers do not directly know the referees. With the active approach, the referrers directly push the SSP to the referees in the form of email or other messaging context, such as posting the SSP to the profile page of a buyer on Facebook.

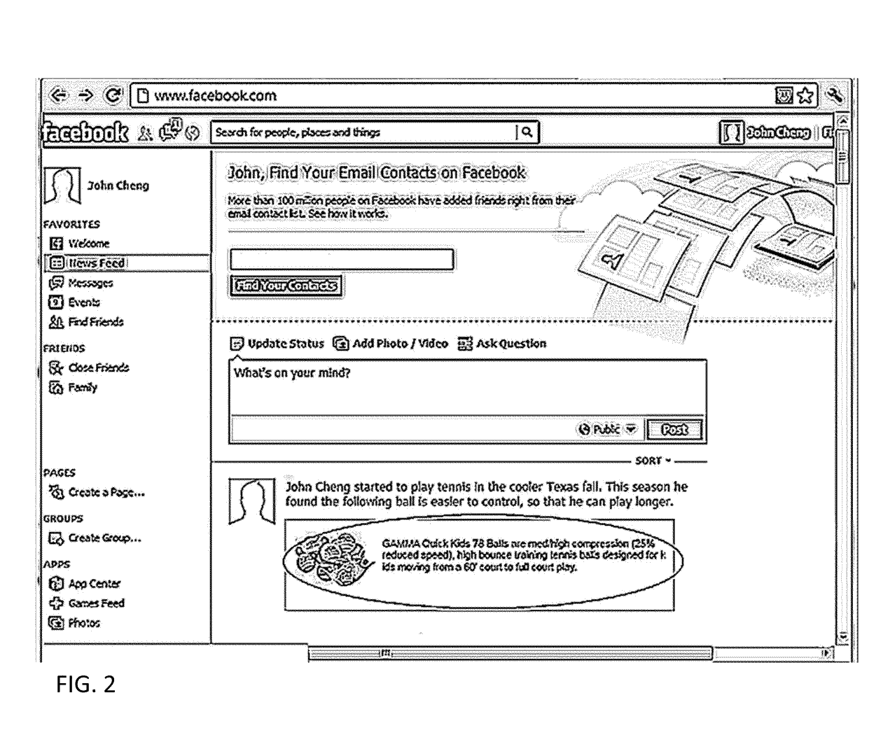

FIG. 2 illustrates an exemplary embodiment of a SSP as implemented within a social networking site. One skilled in the art would appreciate that SSPs may be implemented within any one of a plurality of social networking sites, which may also include, but is not limited to: Facebook, GooglePlus, Tumblr, LinkedIn, Pinterest, Twitter, Instagram, YouTube, LiveJournal, Open Diary, Vox, Xanga, Wooxie, Blogster, etc. In this particular embodiment, the SSP is implemented within Facebook, a social networking service within which users must register before using the site. After creating a personal profile, users may add other users as friends and exchange messages, including automatic notifications when users update their profiles or post messages. Additionally, users may join common interest user groups organized by any one of a plurality of characteristics.

In this embodiment, the SSP has been embedded into a user's Facebook status update and posted for the public to freely view. Status updates (also called a “status”) allows users to post messages for their friends to read. In turn, friends may respond with their own comments, as well as clicking the “Like” button. A user's most recent updates appear at the top of their Timeline or Wall and is also noted in the “Recently Updated” section of a user's friend list. Additionally, the status update may be presented in a News Feed, an alternative home page in which users may view a constantly updated list of their friends' Facebook activity. The News Feed highlights information that includes profile changes, upcoming events, and birthdays, among other updates. The News Feed also shows conversations taking place between the walls of a user's friends. An integral part of the News Feed interface is the Mini-Feed, a news stream on the user's profile page that shows updates about that user. Unlike in the News Feed, the user can delete events from the Mini-Feed after they appear so that they are no longer visible to profile visitors. The News Feed further displays top stories and most recent stories in one feed, and the option to highlight stories to make them top stories, as well as to un-highlight stories. Users may also choose an option within the News Feed to view recent stories first.

Alternatively, the SSP may be posted to another user's or his/her own Facebook Timeline or Wall. The Timeline refers to a virtual space upon which a user's Facebook content is organized and displayed. For example, in a Timeline, the photos, videos, and posts of any given user may be categorized according to the period of time which they were uploaded or created. Posts and events are displayed along a timeline that runs through the center of a user's profile, which the option of adding events that occurred prior to the user joining Facebook as well as having the option of “hiding” posts. The Wall refers to a profile space where Facebook user's content is shown. It allows the posting of messages, often short or temporal notes, for the user to see while displaying the time and date the message was written. A user's Wall is visible to anyone with the ability to see his or her full profile, and friends' Wall posts appear in the user's News Feed. In addition to postings by other users, the Wall also displays other events that happened to the user's profile. It displays when information is changed, when they change their profile picture, and when they connect with new people, among other things.

Further, SSP's may be posted to any one of Facebook's networks, groups, and pages. Facebook allows different “networks” and “groups”, which many users can join and post messages. This is essentially equivalent to control of a blog for the administrators. However these blogs allow some additional controls. For example these allow privacy settings on basis of networks. Groups are used for discussions, events, etc. and are a way of enabling a number of people to come together online to share information and discuss specific subjects. They are increasingly used by clubs, companies and public sector organizations to engage with stakeholders, be they members of the public, employees, members, service users, shareholders or customers. A group includes but is not limited to the following: the members who have joined, recent news contents, wall contents, photos, posted items, videos and all associated comments of such items. In this respect, groups are similar to Facebook pages but contain a different set of features.

Facebook users can create “pages” allowing fans of an individual, organization, product, service, or concept to like or subscribe to the page posts and updates. Pages look and behave much like a user's personal private profile, but they are also integrated with Facebook's advertising system, allowing owners to easily advertise to Facebook's users. Owners (admins) can send updates to their fans, and they also have access to insights and analytics of their fan base. Pages can also be customized by adding new third-party apps, presented in a form of Tab icons on a page. This powerful feature has brought additional functionality—building custom apps and the development of the third-party “social marketing suites.” It is contemplated that SSP's may be implemented as a third-party application within Facebook.

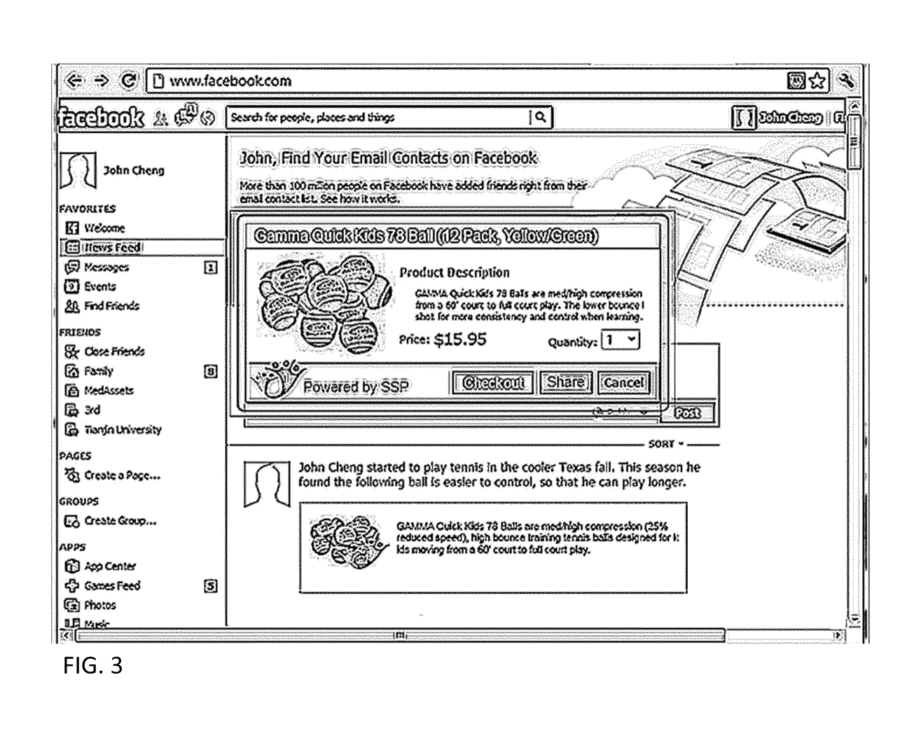

FIG. 3 illustrates a popup for presenting additional SSP information. If a displayed SSP is clicked or otherwise selected, it will display another window for presenting the user with additional information regarding the SSP. Although the popup may be displayed as a new web browser window or a new tab within an internet browser, the popup will preferably be a new window superimposed in front of the underlying browser window displaying social media content. This allows the display of additional information without disrupting the page currently open. Popups may or may not immediately impede a user's ability to view the underlying content, but is designed to attract the user's attention to the popup. Alternatively, the popup window may be displayed as a modal window, a child window that requires users to interact with it before they can return to operating the parent window or application. Model windows may be displayed as a dialog box. This allows the popup modal window to command user awareness, display images in further detail, or present additional information.

The SSP may include a Checkout feature to enable an interacting user to purchase a product or service directly from the social media site, without having to be directed to a different site for payment. When the Checkout button is clicked, a standard payment process begins, which is also handled by an embedded control from a payment process vender, such as PayPal. PayPal currently provides the Embedded Payment Flow for this purpose. Various payment processes capable of remaining on the same page are known to the art.

It is further contemplated that the SSP may include a Share feature to enable an interacting user to share the product or service information with the user's own social network. When the Share button is clicked, the user can then make a copy of the current SSP and replace the owner Id with his own. The copied process can then be embedded into the new user's social page. For example, Facebook User Friend notices a post by his friend, Facebook User John, describing tennis balls that are easier to control. Friend likes the product and clicks on the SSP post to view more information. Friend decides that he does not wish to purchase the balls, but thinks that his own network of friends may like the tennis balls. By clicking on the Share button, the SSP information is posted to his own Facebook Timeline, and any purchases of the tennis balls by his friends by clicking on the SSP link would be attributed to Friend, rather than the original poster, John.

### Example System

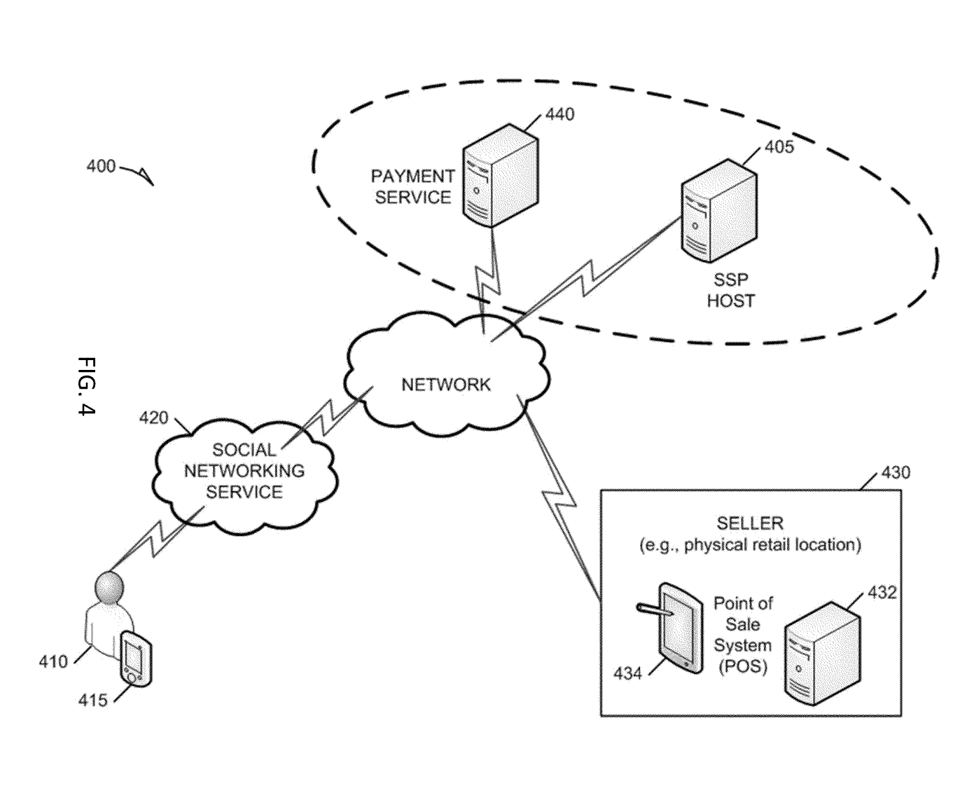

FIG. 4 is a block diagram depicting a system for delivering SSP processes, according to an example embodiment. The system 400 can include a SSP host 405, a user 410, a network-based social networking service 420, a seller 430, and a network-based payment service 440. In an example, the user 410 can connect to the social networking system 420 via a mobile device 415 (e.g., smart phone, PDA, laptop, or similar mobile electronic device capable of some form of data connectivity). In an example, the seller 430 can operate computer systems, such as an inventory system 432 or a point of sale (POS) system 434, among others. The SSP host 405 can interact with any of the systems used by seller 430 for operation of the seller's retail or service business. In an example, the SSP host 405 can work with both the POS system 434 and inventory system 432 to obtain access to inventory available at individual retail locations run by the seller and match merchandise on which the seller wants to offer deals via the SSP host 405. Each merchandise item may be uploaded to the SSP host with its associated information and have a SSP generated for posting on the social networking service 420. Additionally, the payment service 440 can also interact with the seller 430 via the POS system 434, enabling the seller 430 to consume payment services offered by the payment service 440.

### Example Operating Environment

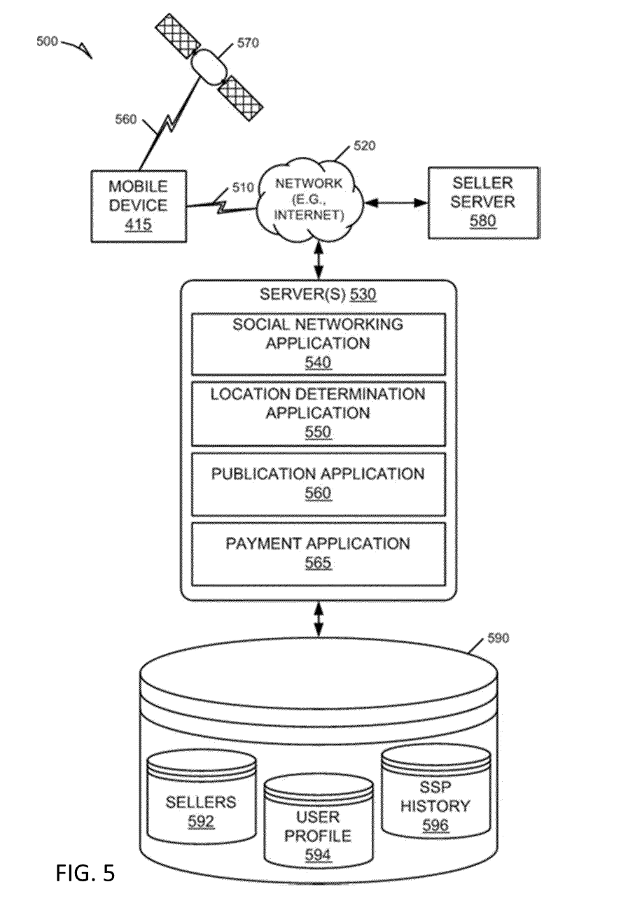

FIG. 5 is a block diagram illustrating an environment for operating a mobile device, according to an example embodiment. The environment 500 is an example environment within which methods of SSP based purchase process can occur. The environment 500 can include a mobile device 415, a communication connection 510, a network 520, servers 530, a communication satellite 570, a seller server 580, and a database 590. The servers 530 can optionally include social networking application 540, location determination application 550, publication application 560, and payment application 565. The database 590 can optionally include seller databases 592, user profile database 594, and/or location history database 596. The mobile device 415 represents one example device that can be utilized by a user to view a SSP offered via the social networking service 420 and process payments for purchased items. The mobile device 415 may be any of a variety of types of devices (for example, a cellular telephone, a personal digital assistant (PDA), a Personal Navigation Device (PND), a handheld computer, a tablet computer, a notebook computer, or other type of movable device). The mobile device 415 may interface via a connection 510 with a communication network 520. Depending on the form of the mobile device 415, any of a variety of types of connections 510 and communication networks 520 may be used.

For example, the connection 510 may be Code Division Multiple Access (CDMA) connection, a Global System for Mobile communications (GSM) connection, or other type of cellular connection. Such connection 510 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 520 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 510 may be Wireless Fidelity (Wi-Fi, IEEE 802.11x type) connection, a Worldwide Interoperability for Microwave Access (WiMAX) connection, or another type of wireless data connection. In such an embodiment, the communication network 520 may include one or more wireless access points coupled to a local area network (LAN), a wide area network (WAN), the Internet, or other packet-switched data network.

In yet another example, the connection 510 may be a wired connection, for example an Ethernet link, and the communication network may be a LAN, a WAN, the Internet, or other packet-switched data network. Accordingly, a variety of different configurations are expressly contemplated.

A plurality of servers 530 may be coupled via interfaces to the communication network 520, for example, via wired or wireless interfaces. These servers 530 may be configured to provide various types of services to the mobile device 415. For example, one or more servers 530 may execute social networking applications 540, which interoperate with software executing on the mobile device 415, to provide SSPs to a user. SSPs provide social-network-specific information regarding items being promoted by referrer, recommendations, notifications, interactive capabilities, and/or other functionality to a user. For example, the social networking application 540 can provide display of SSPs posted to the social networking service 420, which can then be used to assist in completing sales transactions of items associated with the posted SSP and enable payment via the payment service 440. Knowledge of the device's location, and/or the location of other devices, may be obtained through interoperation of the mobile device 415 with a location determination application 550 executing on one or more of the servers 530. Location information may also be provided by the mobile device 415, without use of a location determination application, such as application 550. In certain examples, the mobile device 415 may have some limited location determination capabilities that are augmented by the location determination application 550. Location information may be useful to both the seller and the referrer to determine locations to which they are making sales.

In some examples, the servers 530 can also include publication application 560 for providing location-aware SSP publications that may be triggered by present or past location information of individuals associated with the referrer. This may be used to actively push a SSP to referees that are within geographic range of a seller 430 that the content provided has claimed a SSP with. In certain examples, location data can be provided to the publication application 560 by the location determination application 550. In some examples, the location data provided by the location determination application 550 can include seller information (e.g., identification of a retail location). In certain examples, the location determination application 550 can receive signals via the network 520 to further identify a location. For example, a seller may broadcast a specific IEEE 802.11 service set identifier (SSID) that can be interpreted by the location determination application 550 to identify a particular retail location. In another example, the seller may broadcast an identification signal via radio-frequency identification (REID), near-field communication (NFC), or a similar protocol that can be used by the location determination application 550.

### Example Mobile Device

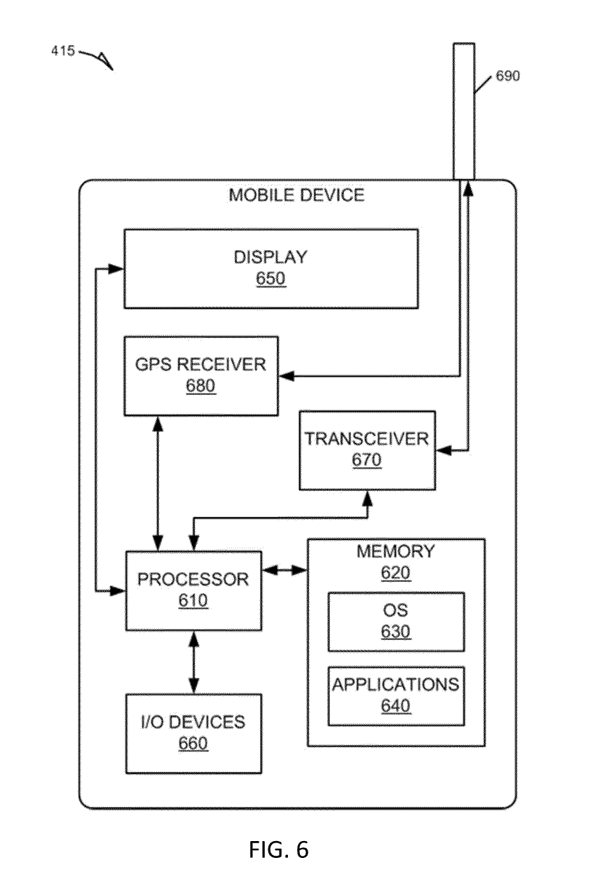

FIG. 6 is a block diagram illustrating a mobile device, according to an example embodiment. The mobile device 415 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor. The memory 620 may be adapted to store an operating system (OS) 630, as well as application programs 640, such as a social networking application that may provide SSPs to a user. The processor 610 may be coupled, either directly or via appropriate intermediary hardware, to a display 650 and to one or more input/output (I/O) devices 660, such as a keypad, a touch panel sensor, a microphone, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 415. In this manner, the connection 610 with the communication network 520 may be established. Further, in some configurations, a GPS receiver 680 may also make use of the antenna 690 to receive GPS signals.

### Example Platform Architecture

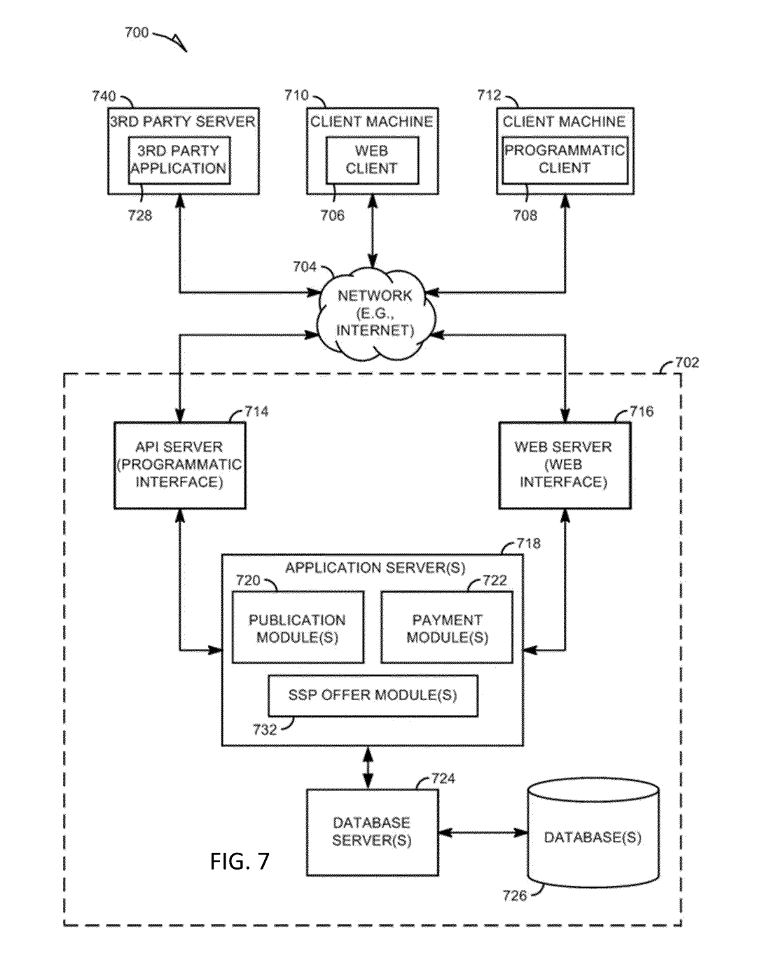

FIG. 7 is a block diagram illustrating a network-based system 700 for delivering SSP services, according to an example embodiment. The block diagram depicts a network-based system 700 (in the exemplary form of a client-server system), within which an example embodiment can be deployed is described. A networked system 702, in the example form of a network-based SSP system, that provides server-side functionality, via a network 704 (e.g., the Internet or WAN) to one or more client machines 710, 712. FIG. 7 illustrates, for example, a web client 706 (e.g., a browser, such as the Internet Explorer browser developed by Microsoft Corporation of Redmond, Wash. State) and a programmatic client 708 (e.g., WHERE™ smartphone application from Where, Inc. of Boston, Mass. or FOURSQUARE™ smartphone application from Foursquare, Inc. of New York, N.Y.) executing on respective client machines 710 and 712. In an example, the client machines 710 and 712 can be in the form of a mobile device, such as mobile device 415.

An Application Programming Interface (API) server 714 and a web server 716 are coupled to, and provide programmatic and web interfaces respectively to, one or more application servers 718. The application servers 718 host one or more publication modules 720 (in certain examples, these can also include social-networking modules, item uploading modules, and SSP claiming modules, to name a few), payment modules 722, and location-aware SSP offer modules 732. The application servers 718 are, in turn, shown to be coupled to one or more database servers 724 that facilitate access to one or more databases 726. In some examples, the application server 718 can access the databases 726 directly without the need for a database server 724.

The publication modules 720 may provide a number of publication functions and services to users that access the networked system 702. The payment modules 722 may likewise provide a number of payment services and functions to users. The payment modules 722 may allow users to accumulate value (e.g., in a commercial currency, such as the U.S. dollar, or a proprietary currency, such as “credits”) in accounts, and then later to redeem the accumulated value for products (e.g., goods or services) that are advertised using SSPs or otherwise made available via the various publication modules 720, within retail locations, or within external online retail venues. The payment modules 722 may also be configured to present or facilitate a purchase of SSP promoted items (e.g., generated by the location-aware SSP modules 732) to a user during their usage of a social networking application 540. The payment modules 722 can also be configured to enable check-in based payment processing. The location-aware SSP offer modules 732 may provide real-time location-aware SSP offers (e.g., coupons or immediate discount deals on targeted products or services) to users of the networked system 402. The location-aware SSP offer modules 732 can be configured to use all of the various communication mechanisms provided by the networked system 702 to present SSP options to users. The SSP offer options can be personalized based on current location, time of day, user profile data, past purchase history, or recent physical or online behaviors recorded by the network-based system 700 (e.g., social networking service), among other things. While the publication modules 720, payment modules 722, and location-aware SSP offer modules 732 are shown in FIG. 7 to all form part of the networked system 702, it will be appreciated that, in alternative embodiments, the payment modules 722 may form part of a payment service that is separate and distinct from the networked system 702, such as the network-based payment service 440. Additionally, in some examples, the location-aware SSP offer modules 732 may be part of the payment service or may form an offer generation service separate and distinct from the networked system 702. In certain examples, the social networking service 420 can include some or all of the application severs 718.

Further, while the system 700 shown in FIG. 7 employs a client-server architecture, the present invention is of course not limited to such an architecture, and could equally well find application in a distributed, or peer-to-peer, architecture system, for example. The various publication modules 720, payment modules 722, and location-aware SSP offer modules 732 could also be implemented as standalone systems or software programs, which do not necessarily have networking capabilities.

The web client 706 accesses the various publication modules 720, payment modules 722, and location-aware SSP offer modules 732 via the web interface supported by the web server 716. Similarly, the programmatic client 708 accesses the various services and functions provided by the publication modules 720, payment modules 722, and location-aware offer modules 732 via the programmatic interface provided by the API server 714. The programmatic client 708 may, for example, be a smartphone application (e.g., the PAYPAL™ payment application developed by eBay, Inc., of San Jose, Calif.) to enable users to make a various of payments directly from their smartphones.

FIG. 7 also illustrates a third party application 728, executing on a third party server machine 740, as having programmatic access to the networked system 702 via the programmatic interface provided by the API server 714. For example, the third party application 728 may, utilizing information retrieved from the networked system 702, support one or more features or functions on a website hosted by the third party. The third party website may, for example, provide one or more promotional, marketplace or payment functions that are supported by the relevant applications of the networked system 702. Additionally, the third party website may provide merchants with access to the SSP offer modules 732 for configuration purposes. In certain examples, sellers can use programmatic interfaces provided by the API server 714 to develop and implement rules-based pricing schemes that can be implemented via the publication modules 720, payment modules 722, and location-aware SSP offer modules 732.

### Example SSP Host

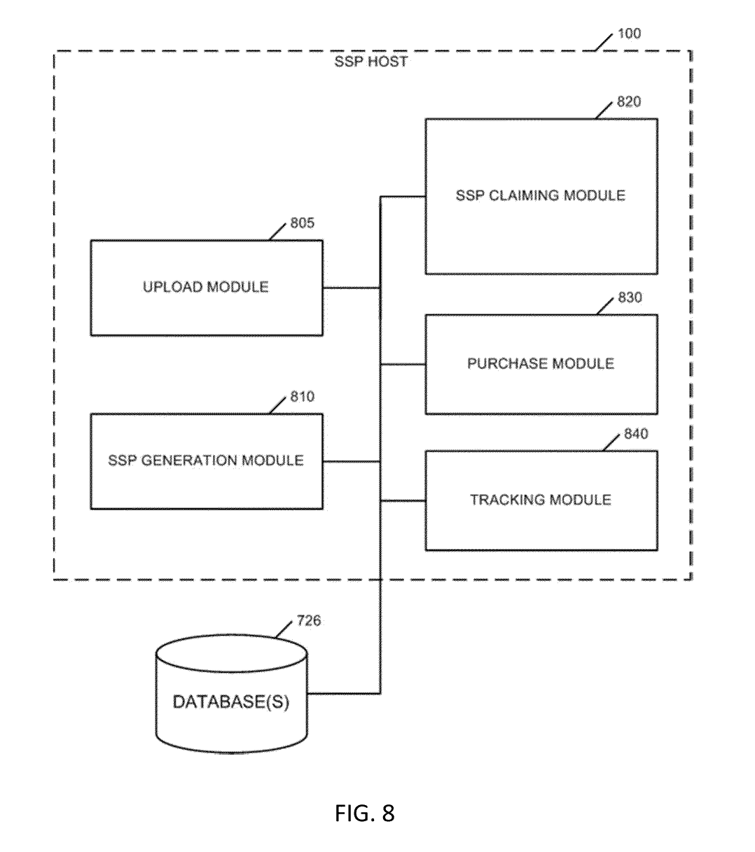

FIG. 8 is a block diagram illustrating an example SSP host, according to an example embodiment. Additional details regarding the functionality provided by the modules of the SSP host are detailed above in reference to FIGS. 1-7.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

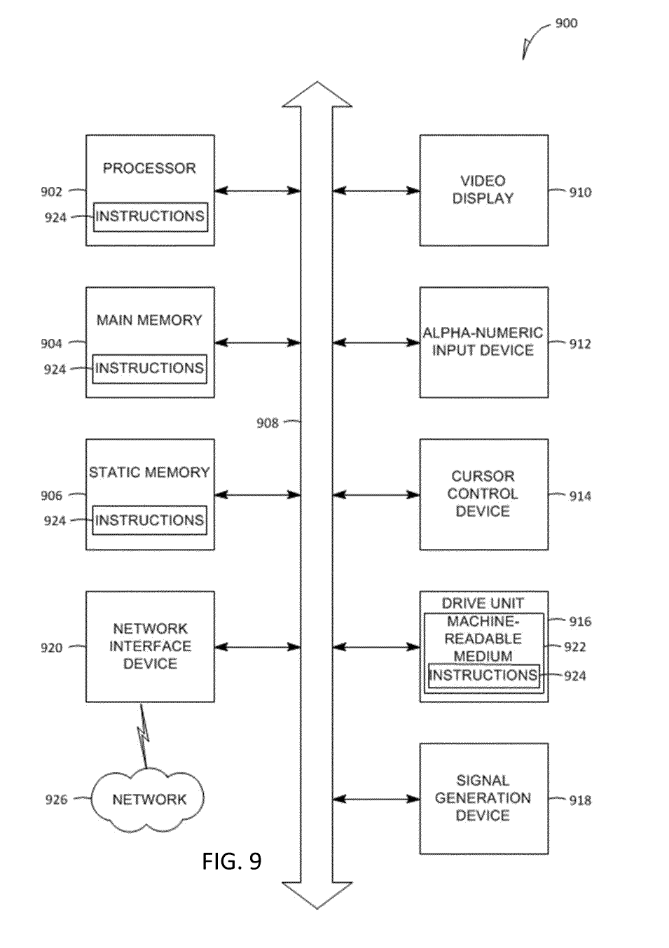

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for providing a social sales point, comprising:
receiving of information associated with an item for sale;
generating, based at least in part on the received information, a web plugin available for claiming;
receiving a claim by a referrer for the web plugin; and
generating the social sales point, wherein the social sales point comprises a SSP coat and a SSP core.

2. The method of claim 1, wherein the receiving of information comprises receiving at least one of a name, a description, a picture, a price, and a quantity associated with the item for sale.

3. The method of claim 1, wherein the item for sale comprises a good or a service.

4. The method of claim 1, wherein the SSP coat comprises a referrer ID and an item ID.

5. The method of claim 4, wherein the SSP coat further comprises a function capable of retrieving the SSP core from a host.

6. The method of claim 1, further comprising receiving a request to dynamically load the SSP core into a website.

7. The method of claim 6, wherein the SSP core is capable of generating a communication of a completed sale.

8. The method of claim 7, further comprising tracking credit owed to a referrer after the completed sale.

9. The method of claim 1, further comprising posting the social sales point to a social networking website.

10. A machine-readable storage device comprising instructions that when executed by at least one processor perform operations comprising:
receiving of information associated with an item for sale;
generating, based at least in part on the received information, a SSP available for claiming;
receiving a claim by a referrer for the SSP; and
generating the social sales point, wherein the social sales point comprises a SSP coat and a SSP core.

11. The machine-readable storage device of claim 10, further comprising instructions that when executed perform operations comprising:
receiving a request to dynamically load the SSP core into a website.

12. The machine-readable storage device of claim 11, further comprising instructions that when executed perform operations comprising:
generating a communication of a completed sale using the SSP.

13. The machine-readable storage device of claim 12, further comprising instructions that when executed perform operations comprising:
tracking reward owed to a referrer after the completed sale.

14. The machine-readable storage device of claim 10, further comprising instructions that when executed perform operations comprising:
receiving at least one of a name, a description, a picture, a price, an identification of the item for sale, and an identification of the referrer.

15. The machine-readable storage device of claim 10, further comprising instructions that when executed perform operations comprising:
retrieving the SSP core from a host through the SSP coat.

16. The machine-readable storage device of claim 10, further comprising instructions that when executed perform operations comprising:
posting the social sales point to a social networking website.

17. The machine-readable storage device of claim 10, wherein the item for sale comprises a good or a service.

18. The machine-readable storage device of claim 10, wherein the SSP coat comprises a referrer ID and an item ID.
